(19) United States
(12) Patent Application Publication
(10) Pub. No.: US 2005/0189767 A1
(43) Pub. Date: Sep. 1, 2005

(54) Spacer for putting into place on a tubular element

(75) Inventor: Jean-Claude Lancien, Cuvergnon (FR)

Correspondence Address: Marina F. Cunningham;McCormick, Paulding & Huber LLP, CityPlace II, 185 Asylum Street, Hartford, CT, 06103, US

(73) Assignee: GREMCO S.A., Saint Ouen (FR)

(21) Appl. No.: 10/643,844

(22) Filed: Aug. 19, 2003

(30) Foreign Application Priority Data
Aug. 21, 2002 (FR) 0210442

(51) Int. Cl. F16B 4/00; F16L 25/00

(52) U.S. Cl. 285/381.1

(57) ABSTRACT

A spacer for putting into place on a tubular element includes firstly a sleeve of high-compressibility cellular material, the sleeve presenting a wide slot extending over its entire length and defining a central passage that is essentially cylindrical- and being of diameter greater than the nominal diameter of the tubular element, and secondly a sheath of heat-shrink plastics material surrounding the split sleeve at least as far as the end edges thereof. The sheath is partially shrunk on the split sleeve firstly so as to hold the split sleeve in the open state for putting the spacer into place on the tubular element, and secondly so as to be able subsequently to be heat-shrunk to clamp the split sleeve and fix the spacer in position.

This application is entitled to the benefit of and incorporates by reference essential subject matter disclosed in French Patent Application No. 02 10442 filed on Aug. 21, 2002.

### FIELD OF THE INVENTION

The present invention relates to a spacer for putting into place on a tubular element.

### BACKGROUND OF THE INVENTION

In motor-driven or vibrating structures, it is common practice to use elements that are put into place on tubes or pipes in order to keep said tubes or pipes out of contact with a nearby wall or another tube or another pipe that is nearby. Such elements are conventionally referred to as “spacers”.

In the field of the automotive industry, it is common practice to make use specifically of spacers that are put into place on a flexible or semirigid tubular pipe in order to prevent said tubular pipe coming into contact with an adjacent surface, for example the inside surface of the vehicle hood, or with a surface whose temperature is high, or indeed in order to avoid contact that might lead to undesirable banging or noise.

When it is not possible to thread the spacer onto the tubular element in question, this function is performed by clip-on elements, for example made in the form of C-shaped clips. Nevertheless, such clip-on elements lead to dimensional problems insofar as it is necessary to have elements that are specific to each pipe or hose, which implies that special molding tools are required on each occasion. Furthermore, the molded elements are generally relatively hard, and as a result the contact they make with a vibrating surface frequently generates banging or other undesirable noise.

When it is possible to thread the spacer onto the tubular element in question, it is then general practice to use a ring which must be kept in place in the right position on the tubular element. This is done either by adhesive, or by using an additional clamping collar, but in all cases this assumes an additional operation or an additional component that can be subject to wear or to corrosion.

The closest state of the art is illustrated by document DE-B-1 475 841 which describes a spacer constituted by two complementary half-sleeves of cellular material and a connecting belt of heat-shrink material which is closed by a snap-fastened connection. When the belt shrinks, it compresses the two half-sleeves and fixes the spacer in position on the tube on which it has been threaded. It should be observed that the edges of the two half-sleeves are touching before the belt is shrunk, such that the clamping process takes place by partially flattening the two half-sleeves. In addition, the presence of snap-fastening connection members on the two axial edges of the belt constitutes a significant practical drawback, since said members are necessarily rigid so that the snap-fastening connection is not damaged during shrinking of said belt.

DE-A-2 312 417 describes installing a heat-shrink sheath on a fiber sleeve which is wound helically to form a cylinder, followed by shrinking the sheath so as to clamp the sleeve on a supporting mandrel. It should be observed that that does not constitute a spacer threaded onto a tube.

U.S. Pat. No. 4,915,425 illustrates the use of a heat-shrink sheath for keeping a sleeve in position on a corrugated tube, shrinkage of the projecting portion enabling one of the corrugations of the tube to be enveloped, thereby locking the sleeve in place. It should be observed that the lengths of heat-shrink sheath are applied only to the end of the sleeve.

DE-A-3 635 515 shows a pipe using a thermal lagging sleeve made of closed-pore polyurethane foam.

### SUMMARY OF THE INVENTION

An object of the present invention is to devise a spacer of the type that can be threaded on a tubular element, the spacer being arranged to be capable of being put into place easily and quickly in the appropriate position on said tubular element.

The invention thus provides a spacer for putting into place on a tubular element, of structure enabling it to keep in position both easily and reliably, regardless of the nature of the tubular element and/or the surface profile of said tubular element.

According to the invention, this problem is solved by a spacer comprising firstly a sleeve of high-compressibility cellular material, said sleeve presenting a wide slot extending over its entire length and defining a central passage that is essentially cylindrical, of diameter that is greater than the nominal diameter of the tubular element, and secondly a sheath of heat-shrink plastics material surrounding the split sleeve at least as far as the end edges thereof, said sheath being partially shrunk on the split sleeve firstly so as to hold said split sleeve in the open state for putting the spacer into place on the tubular element, and secondly so as to be able subsequently to be heat-shrunk to clamp said split sleeve and fix said spacer in position.

Such a spacer structure can be put into place and fixed in position on tubular elements of a very wide variety of types as to their nature and their surface profile.

The sleeve of cellular material may present a slot extending axially, or in a variant a slot extending obliquely or helically. In any event, the width of the slot should be sufficient to generate a substantial increase in diameter when said split sleeve is open so as to make it easier to put the spacer into place on the tubular element.

Provision can be made for the partially-shrunk sheath to end close at the end edges of the split sleeve, or else for it to overlap, at least partially, the end edges of said split sleeve.

When it does overlap the end edges of the split sleeve, provision can be made for the sheath to extend beyond at least one of the end edges so as to form a cylindrical lip of inside diameter greater than the nominal diameter of the tubular element, said cylindrical lip extending the sheath also being capable of participating in fixing the spacer in position in addition to the clamping effect already obtained by shrinkage, by means of adhesive provided on the inside face of said lip.

Also advantageously, the sheath presents external identification marking and/or color.

Finally, the split sleeve is preferably made of closed-cell cellular foam, and the sheath is made of a plastics material that is both heat-shrinkable and suitable for providing mechanical and/or chemical protection to the split sleeve.

Other characteristics and advantages of the invention appear more clearly in the light of the following description and the accompanying drawings, relating to a particular embodiment.

### BRIEF DESCRIPTION OF THE DRAWINGS

Reference is made to the figures, in which:

FIG. 1 is a perspective view of a spacer in accordance with the invention, in which the partially-shrunk sleeve partially overlaps the end edges of the split sleeve made of cellular material;

FIG. 2 is a section on II-II of FIG. 1, showing more clearly the structure of the spacer;

FIG. 3 is a section on III-III of FIG. 2, showing more clearly the wide slot in the open inner sleeve;

FIG. 4 is a perspective view showing the above-mentioned spacer being put into place on a tubular element;

FIG. 5 and FIG. 6 which is a section on VI-VI show the spacer in place at the intended position on the tubular element;

FIG. 7, and FIG. 8 which is a section on VIII-VIII, show said spacer being fixed in position by shrinking its peripheral sheath, with clamping and closure of the split sleeve;

FIG. 9 is a perspective view of a segment of sheath that has not yet been shrunk, and a split sleeve with a slot that is either axial or helical;

FIG. 10 shows various axial section views corresponding to lengths of sheath that are respectively equal to, longer than, and much longer than the axial length of the split sleeve, the spacer being shown in its position that corresponds to the peripheral sleeve being partially shrunk; and

FIG. 11 is a perspective view corresponding to variant c) in FIG. 10, after final shrinking of the sheath on the spacer once in position.

### DETAILED DESCRIPTION OF THE INVENTION

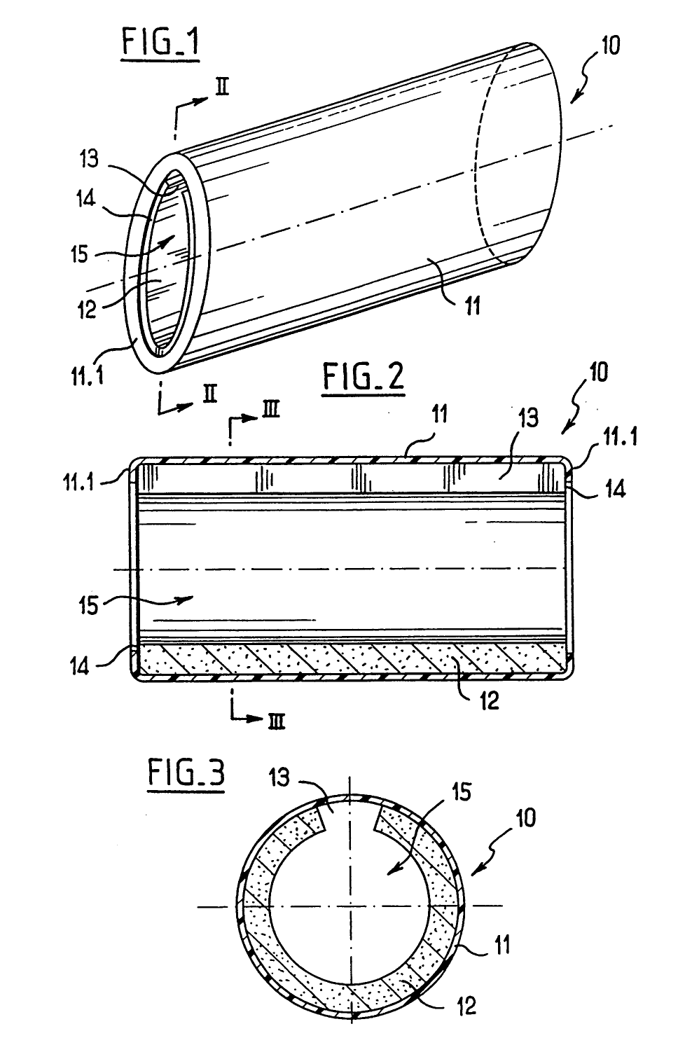

In FIGS. 1 to 3, there can be seen a spacer referenced 10 for putting into place on a tubular element, which tubular element may be a pipe or a hose of any kind, and of any type of profile, adopting a twisted or straight shape suitable for enabling said tubular element to be used.

The spacer 10 comprises firstly a sleeve 12 of high compressibility cellular material, said sleeve presenting a wide slot 13 extending along its entire length and defining an essentially cylindrical central passage 15 of diameter that is greater than the nominal diameter of the tubular element concerned. The spacer 10 also comprises a sheath 11 of heat-shrink plastics material surrounding the split sleeve 12 at least as far as its end edges referenced 14

FIGS. 1 to 3 show the spacer 10 in its state corresponding to the sheath 11 being partially shrunk on the split sleeve 12, which corresponds to the state in which the spacer is stored prior to being put into place and fixed in position on a tubular element. It will be understood that in this state, the sheath 11 still possesses the ability of being shrunk further, so as to reduce its circumferential size, and consequently clamps the split sleeve 12 by reducing the width of the slot 13 therein, which slot may be reduced to zero width in the event of the two axially-extending edges coming into contact with each other after final shrinking of the sheath.

Thus, in accordance with an essential characteristic of the invention, the sheath 11 is partially shrunk on the split sleeve 12 firstly so as to hold said split sleeve in the open state for putting the spacer into place on the tubular element, and secondly so as to be subsequently capable of being heat-shrunk to clamp said split sleeve and fix said spacer in position.

Specifically, the partially-retracted sheath 11 partially overlaps the end edges 14 of the split sleeve 12 by means of terminal flaps 11.1, however as explained below, this is naturally only one particular embodiment. Nevertheless, due to the terminal flaps of the sheath 11 lying against the end edge 14, this embodiment presents the advantage of ensuring that the split sleeve 12 is held in place in the manner of a confinement box, thereby protecting the split sleeve 12 and avoiding any loss of said sleeve while the spacer is being handled for the purpose of being put into place.

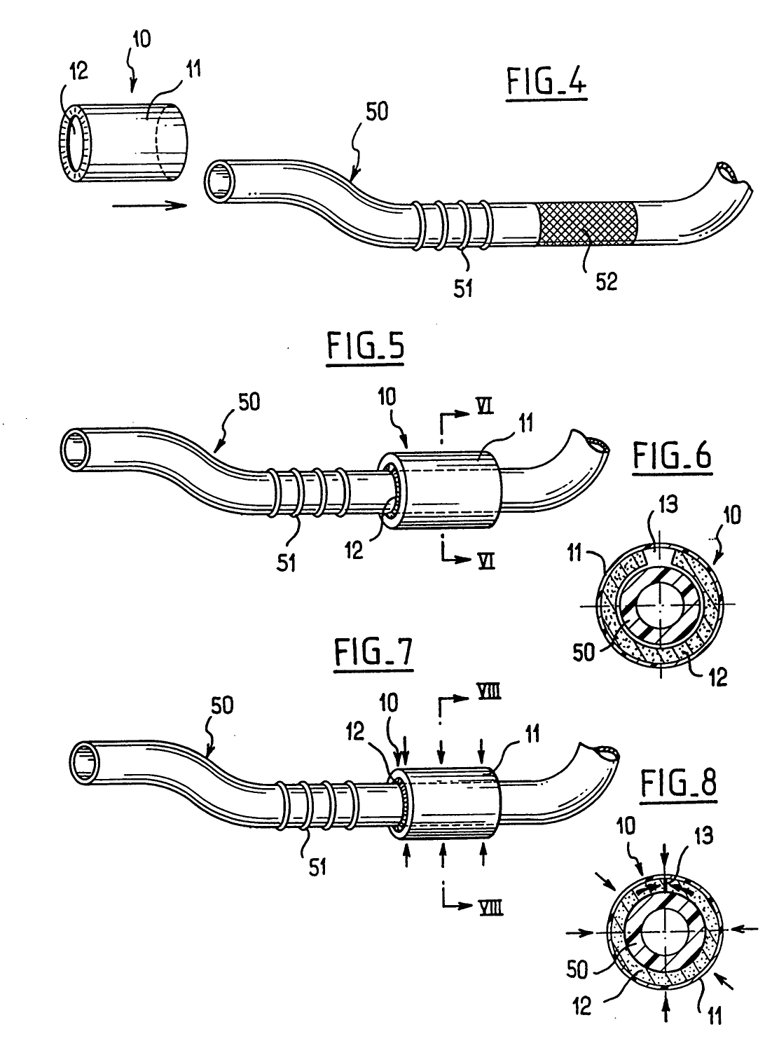

The putting into place and fixing in position of the above-described spacer on a tubular element is described below with reference to FIGS. 4 to 8.

FIG. 4 shows a tubular element 50 constituted in this case by a flexible or semirigid hose having outside surface portions that are smooth as well as having corrugations 51. Reference 52 designates the desired position for the spacer 10. The spacer 10 is thus threaded onto the tubular element 50 over one end thereof, preferably the end corresponding to bending having the largest radius of curvature so as to avoid deforming the spacer excessively, which spacer nevertheless presents a certain amount of flexibility in elastic deformation while it is being put into place. The opening in the split sleeve 12 makes it particularly easy for it to pass over the rings 51 if it is desired to put the spacer 10 into place in a zone 52 that corresponds to an outside surface that is smooth. Naturally, in a variant, the spacer 10 could be put into place specifically on a zone that corresponds to the corrugations, and that would change nothing as to the ease and reliability with which said spacer is fixed in position after final shrinkage of the peripheral sheath.

FIGS. 5 and 6 show the spacer 10 put into place in the desired position, and it can be seen that the slot 13 is still of considerable width corresponding to the maximum diameter for the central passage of the split sleeve.

FIGS. 7 and 8 show the above spacer after the peripheral sheath 11 has been shrunk (symbolized by radial arrows), which shrinkage leads to the split sleeve 12 being clamped onto the tubular element and to the spacer 10 being fixed in position. It can be seen that the slot 13 is then reduced to almost zero width after the split sleeve 12 has been fully clamped. Naturally, variants could be devised in which the width of the slot is small but not zero, with the spacer nevertheless still being securely held in position.

The sheath 11 of the spacer 10 thus performs several functions, the first of which is to ensure that the split sleeve is held in the open state so as to make it easier to install the spacer by threading it onto the tubular element concerned. The second function consists in clamping the split sleeve by shrinking circumferentially, thereby fixing the position of the spacer on the tubular element in the desired location. Provision can also be made for the sheath to present external identification marking and/or color, thus making it possible to perform an additional function of providing information (variant not shown).

Finally, by the particular material selected to constitute it and/or by its dimensions, provision can also be made for the sheath 11 to perform a function of protecting the split sleeve 12 mechanically and/or chemically.

In practice, it is preferable for the split sleeve 12 to be made of a material such as a closed-cell cellular foam. It is thus possible to use existing foams based on nitril, ethylene-propylene diene monomer (EPDM), butylene, or indeed synthetic rubber or silicone. The sheath 11 may be made of any heat-shrink material suitable for the application in question, in particular polyethylene or polyvinyl chloride.

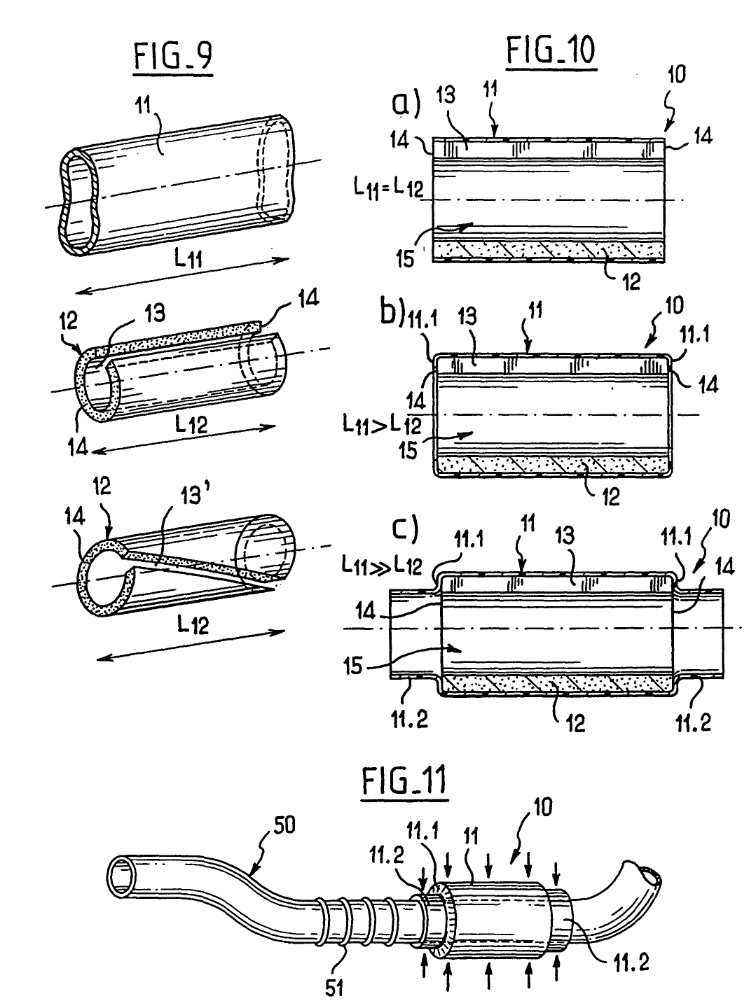

FIG. 9 shows a segment of sheath 11 in the non-shrunk state, i.e. a state in which it is freely cylindrical, with an axial length written L ₁₁. There can also be seen a split sleeve 12 of axial length written L₁₂. In this figure, there is shown one variant in which the slot 13 extends axially, as described above, and another variant in which the slot 13′ extends obliquely or helically.

Since the sheath 11 in the partially-shrunk state is required to surround the split sleeve 12 at least as far as its end edges 14, it is necessary for L₁₁ to be greater than or equal to L₁₂.

FIG. 10 shows variants depending on the differences between the above-specified parameters L₁₁ and L ₁₂.

In a), L₁₁=L₁₂ such that the sheath 11 in the partially-shrunk state terminates exactly at the end edges 14 of the split sleeve 12.

In b), L₁₁>L₁₂, such that the sheath 11 in the partially-shrunk state overlaps the end edges 14 of the split sleeve 12 at least in part, as in the case of the embodiment described above. The sheath 11 then presents reentrant rims 11.1 over the end edges 14 of the split sleeve 12, and as described above this enables the split sleeve 12 to be held in place in the sheath which might otherwise float to some extent inside its cylindrical covering.

In c), L₁₁>>L₁₂, so that the sheath 11 extends beyond at least one of the end edges 14 of the split sleeve 12, forming a cylindrical lip referenced 11.2 and of inside diameter greater than the nominal diameter of the tubular element 50 concerned. Specifically, provision is made for the sheath 11 to extend beyond both end edges 14, thereby forming at each end of the split sleeve a cylindrical lip 11.2. In addition to holding the split sleeve in position while the sheath is in the partially-retracted state, this third variant makes it possible to have two heat-shrink collar-forming rings which constitute bands around the tubular element on which the spacer is installed. These rings shrink onto the tubular element during shrinkage of the sheath, thereby reinforcing the axial locking in position of the spacer. It is possible to further reinforce the strength with which the spacer is held in position by optionally providing adhesive on the inside space of the or each cylindrical lip 11.2 extending the sheath 11.

FIG. 11 shows the spacer 10 corresponding to this third variant, after final shrinkage of the sheath 11, both in its central portion surrounding the split sleeve 12 and in its two cylindrical lips 11.2.

In all cases, final shrinkage of the peripheral sheath of the spacer 10, after said spacer has been put into place, can be performed by any means that are conventional for this purpose, such as passing through a tunnel oven or in the vicinity of a suitable heater member.

The putting into place of the spacer as described above, and its holding in position by final shrinkage of its peripheral sheath constitutes a method that is both simple and very fast. In addition, the flexibility of the peripheral zone of the spacer which is still preserved after final shrinkage of the sheath of said spacer also makes it possible to provide a noise-damping function by avoiding any risk of banging or undesirable vibration.

Finally, the materials constituting the spacer can easily be selected to enable said spacer to be recycled after it has been removed from its tubular element.

A spacer has thus been provided whose structure is both simple and suitable for enabling the spacer to be put into place quickly and reliably on any type of tubular element.

The invention is not limited to the embodiments described above, but on the contrary covers any variant using equivalent means to reproduce the essential characteristics specified above.

1. A spacer for putting into place on a tubular element, the spacer comprising firstly a sleeve of high-compressibility cellular material, said sleeve presenting a wide slot extending over its entire length and defining a central passage that is essentially cylindrical, of diameter greater than the nominal diameter of the tubular element, and secondly a sheath of heat-shrink plastics material surrounding the split sleeve at least as far as the end edges thereof, said sheath being partially shrunk on the split sleeve firstly so as to hold said split sleeve in the open state for putting the spacer into place on the tubular element, and secondly so as to be able subsequently to be heat-shrunk to clamp said split sleeve and fix said spacer in position.

2. A spacer according to claim 1, wherein the sleeve presents a slot that extends axially.

3. A spacer according to claim 1, wherein the sleeve presents a slot that extends obliquely or helically.

4. A spacer according to claim 1, wherein the partially-shrunk sheath stops at the end edges of the split sleeve.

5. A spacer according to claim 1, wherein the partially-shrunk sheath overlaps the end edges of the split sleeve at least in part.

6. A spacer according to claim 5, wherein the sheath extends beyond at least one of the end edges of the split sleeve, forming a cylindrical lip of inside diameter greater than the nominal diameter of the tubular element.

7. A spacer according to claim 6, wherein the cylindrical lip extending the sheath contributes to fixing the spacer in position by virtue of adhesive provided on the inside face of said lip.

8. A spacer according to claim 1, wherein the outside of the sheath presents identification marking and/or color.

9. A spacer according to claim 1, wherein the split sleeve is made of closed-cell cellular foam.

10. A spacer according to claim 1, wherein the sheath is made of plastics material that is both a heat-shrink material and suitable for providing the split sleeve with mechanical and/or chemical protection.
